(19) United States
(12) Patent Application Publication
(10) Pub. No.: US 2005/0167000 A1
(43) Pub. Date: Aug. 4, 2005

(54) System for forming dados

(76) Inventor: Spencer B. Dick, Portland, OR (US)

Correspondence Address: KOLISCH HARTWELL, P.C., 520 S.W. YAMHILL STREET, SUITE 200, PORTLAND, OR, 97204, US

(21) Appl. No.: 10/958,690

(22) Filed: Oct. 4, 2004

Related U.S. Application Data
(60) Provisional application No. 60/508,440, filed on Oct. 3, 2003.

(51) Int. Cl. B27B 31/00

(52) U.S. Cl. 144/253.1

(57) ABSTRACT

A system for forming dados in a work piece uses a pusher to move the work piece successive increments between saw cuts.

### CROSS REFERENCE TO RELATED APPLICATION

This application claims priority under 35 U.S.C. § 119 and applicable foreign and international law of U.S. Provisional Patent Application Ser. No. 60/508,440 filed Oct. 3, 2003, each of which is hereby incorporated by reference in its entirety.

This application incorporates by reference in its entirety the following U.S. patent applications and patents: U.S. Provisional Patent Application Ser. No. 60/405,067 filed Aug. 20, 2002 entitled “Rip Fence Control System Improvements”; U.S. Provisional Patent Application Ser. No. 60/405,069 filed Aug. 20, 2002 entitled “System and Method for Automated Material Processing”; U.S. patent application Ser. No. 09/578,806 filed May 24, 2000 entitled “Automated Fence Control Coupling System”; U.S. patent application Ser. No. 09/861,231 filed May 17, 2001 entitled “System and Method of Marking Materials for Automated Processing”; U.S. patent application Ser. No. 10/104,492 filed Mar. 22, 2002 entitled “Automated Fence Control Coupling System”; U.S. Provisional Patent Application Ser. No. 60/405,068 filed Aug. 20, 2002 entitled “Process Management System and Method”; and U.S. Pat. Nos. 491,307; 2,315,458; 2,731,989; 2,740,437; 2,852,049; 3,994,484; 4,111,088; 4,434,693; 4,658,687; 4,791,757; 4,805,505; 4,901,992; 5,251,142; 5,443,554; 5,444,635; 5,460,070; 5,524,514; and 6,216,574.

### FIELD OF THE INVENTION

The invention relates to devices for controlling linear movement of an object such as a fence on a table saw, particularly devices and methods of automatically forming a dado in a workpiece on a table saw.

### BACKGROUND OF THE INVENTION

Significant effort and attention has been directed over the years at automating material handling and manufacturing. Ultimately, material processing equipment must be cost effective to manufacture and use. Therefore, innovation is needed to produce manufacturing equipment that is affordable, in view of its intended use, without sacrificing or compromising precision, accuracy, and overall functional performance.

Table saws may be equipped with a movable fence to allow an operator to set desired cut dimensions. Table saw fences typically are movable along a rail that is bolted along one side of the table saw. An operator may slide the fence back and forth along the rail and then lock the fence in place by means of a locking handle. Many such table saws are sold in a design that requires manual adjustment of the fence.

Sometimes it is desirable to use a table saw in an automated or semi-automated capacity. Digital positioning systems are available for adding on to a table saw that has a manually operable fence. Aftermarket automated fence positioning systems may be cumbersome to install. Some positioning systems are not flexible enough to be easily mounted on different table saw configurations.

Sometimes it is necessary to form dados in a workpiece, for example, to support a shelf in a cabinet. A router may be used to cut a dado. Alternatively, a stack of blades may be used to machine grooves in the side of a workpiece. However, assembling blade stacks and positioning workpieces for cutting is time consuming and labor intensive.

### SUMMARY OF THE INVENTION

The invention provides automated fence positioning systems that quickly and accurately reposition a fence in the course of executing a pre-determined cut or sequence of cuts on a table saw including incremental cutting to form one or more dados in a workpiece.

### BRIEF DESCRIPTION OF THE FIGURES

FIG. 1 is a perspective view of an automated fence positioning system.

FIG. 2 is a partial cross-sectional view of the system shown in FIG. 1.

FIG. 3 is a close-up view of a coupling device shown in FIG. 2.

FIG. 4 is a partially exploded view of a rail section and a carriage device configured to move inside the rail.

FIGS. 5 and 6 show side views of a bearing support member, without and with a bearing assembly, respectively.

FIGS. 7 and 8 show close-up details of FIGS. 5 and 6, respectively.

FIGS. 9 and 10 show side views of brackets used to couple, in parallel, a fence positioning rail to a fence guide rail.

FIGS. 11 and 12 are perspective views, exploded and assembled, respectively, of the coupling device shown in FIGS. 9 and 10.

FIG. 13 is a perspective view of another linkage device.

### DESCRIPTION OF EXAMPLES OF THE INVENTION

The invention has numerous aspects and permutations in addition to the examples described below. In a preferred example an automated positioner on a table saw automatically pushes a workpiece to an appropriate location for cutting a dado. If the width of the dado is greater than the width of the blade then the positioner may move the workpiece incrementally between cuts so that adjacent multiple cuts combine to form the desired dado dimension.

For example, an operator may enter into the controller, the width of the saw blade such as ⅜-inch. Assuming the desired dado width is ¾ inch, and that the plan configuration calls for dados every eight inches along a length. The positioner or pusher then moves a workpiece to the first position and makes a cut. The width of the cut is ⅜-inch, equal to the width of the blade. The positioner then moves the workpiece another increment of ⅜-inch, and a second cut is made. This results in a groove or dado having a width of ¾-inch. The positioner then moves the workpiece eight more inches in position for cutting a second dado, etc.

Dado sets previously had to be adjusted in a time consuming process to allow for the variance in plywood. With this invention, the width of the plywood is entered into the controller and the fence automatically compensates for this.

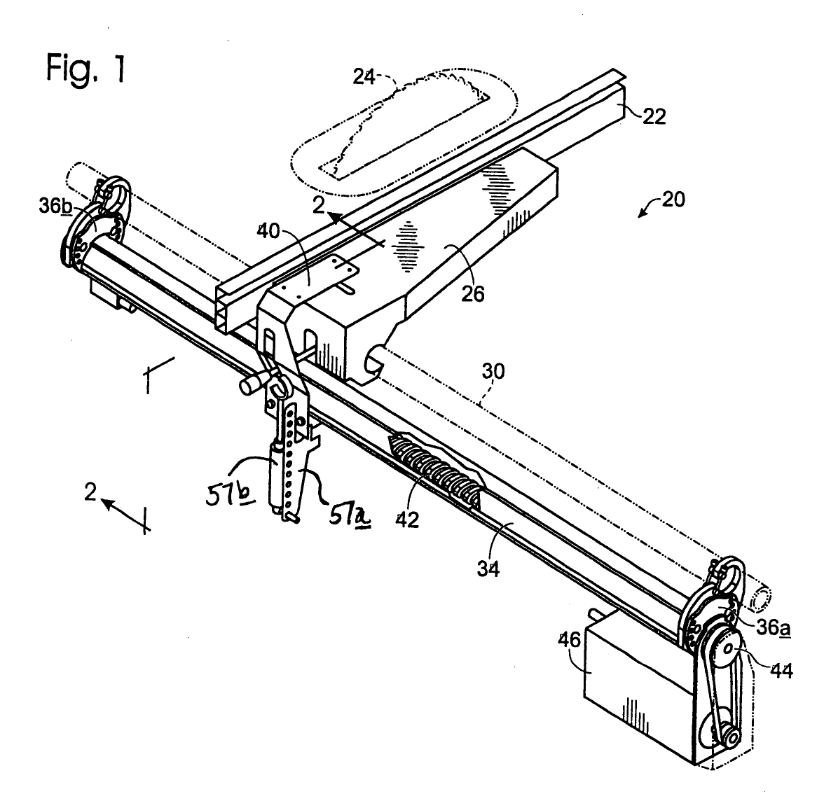

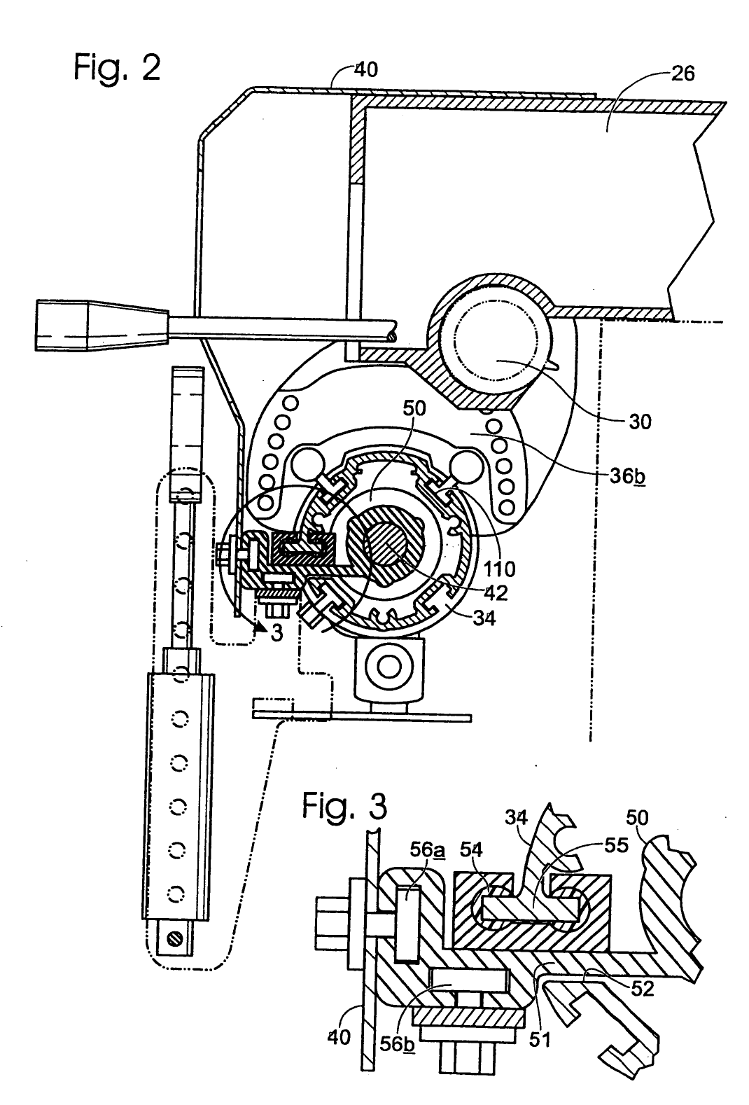

FIG. 1 shows a perspective view of an exemplary fence control system 20. Fence 22 is provided on a table saw to index a piece of material for cutting relative to saw blade 24. Fence 22 is connected to fence support member 26 which is slidably connected to fence positioning rail 30. Fence positioning rail 30 is coupled to positioning guide rail 34 via clamps or linkage devices 36a and 36b. Carriage coupling device 40 rigidly connects fence support member 26 to a carriage (shown in FIGS. 2-4) which moves inside positioning guide rail 34. Screw member 42 is driven by belt and pulley assembly 44 and a motor inside housing 46 to move the carriage along with carriage coupling device 40, fence support member, and fence 22 to properly position materials for cutting.

FIG. 2 is a cross-sectional view through the assembly of FIG. 1 showing the linkage between internal carriage 50 and carriage coupling device 40. A close-up view of the linkage is shown in FIG. 3. Carriage 50 has a cylindrical portion that has internal threads complimenting threads on screw shaft 42. The cylindrical portion of carriage 50 is contained entirely inside positioning guide rail 34. Carriage 50 also has a flange portion 51 that extends through slot 52 and runs substantially the entire length of positioning guide rail 34. Flange portion 51 includes three T-slots. One T-slot has anti-friction surface material 54 so that carriage 50 can move with a low coefficient of friction relative to T-structure 55 on positioning guide rail 34. Two other T-slots are provided. T-slot 56a receives one or more bolts for securing fence structure coupling device 40. T-slot 56b receives one or more bolts for securing interlock plate member 57a. Interlock device 57b is mounted on plate member 57a, and operates to prevent operation of the machine while the carriage is moving. The T-slot configuration shown in FIG. 3 provides a rigid, sturdy connection between carriage 50 and carriage coupling device 40, thus enabling carriage 50 to move smoothly on a single rail portion 55 without contacting any other internal surface inside positioning guide rail 34. Therefore, the positioning system can operate with significantly less friction making the device more efficient to operate and less expensive to produce compared to prior positioning systems. Alternative slot arrangements may be used. Other types of fastening devices, for example, bolts with nuts, soldered or welded connections, etc. may also be used.

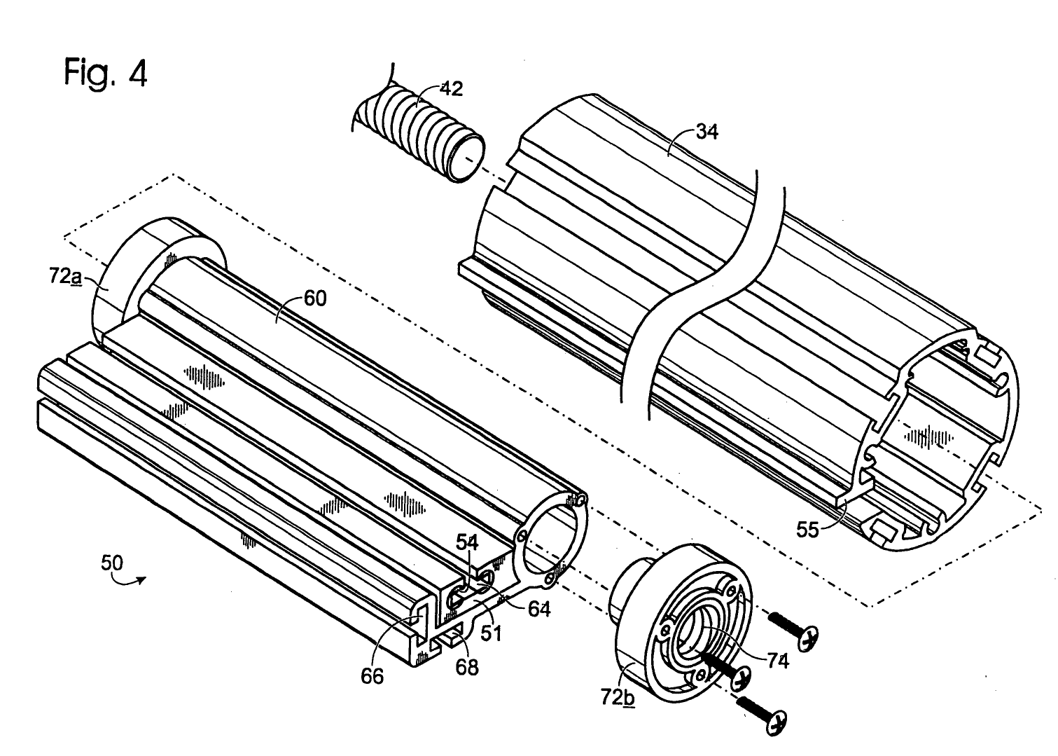

In FIG. 4, a portion of positioning guide rail 34 receives carriage 50. Carriage 50 includes cylindrical portion 60 connected to flange portion 51. Flange portion 51 includes three T-slots 64, 66, and 68 for receiving T-structures, as discussed above and shown in FIG. 3. Collar members 72a and 72b are secured at opposite ends of carriage 50, and are provided with internal threads 74 complimenting external threads on screw 42.

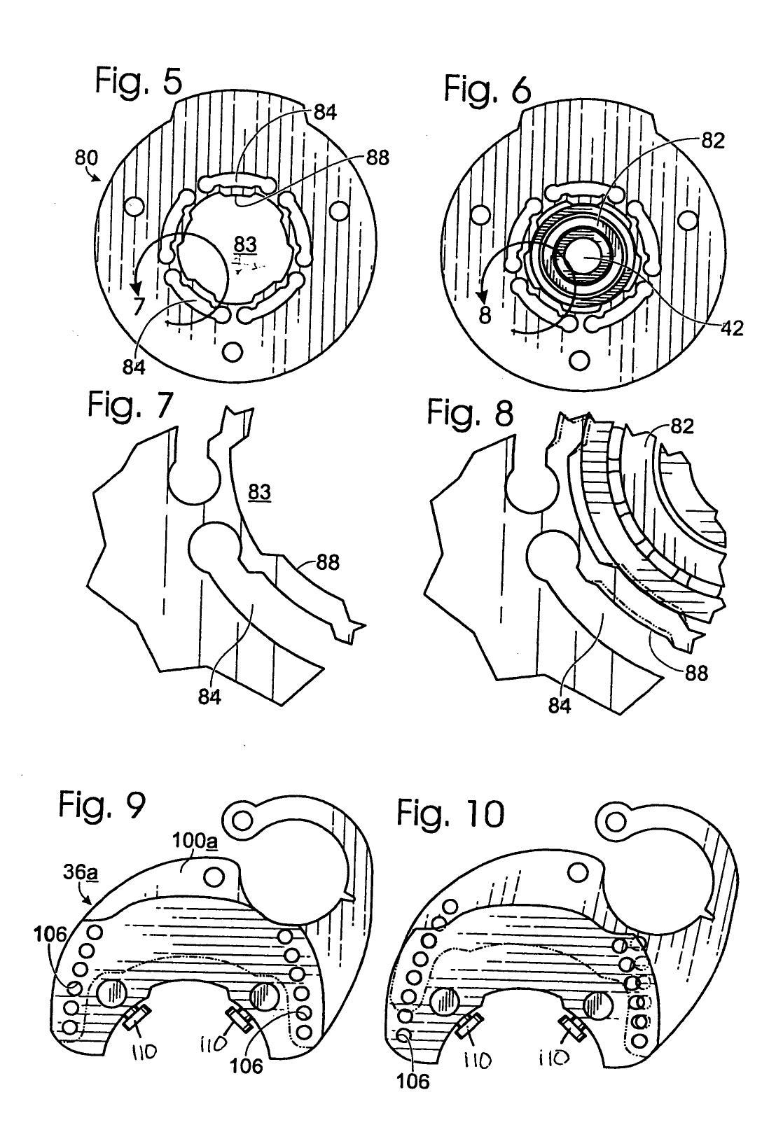

FIGS. 5-8 illustrate a support device 80 for holding a bearing assembly 82. Bearing support devices 80 may be used at opposite ends of positioning guide rail 34 to support screw 42 to permit driven rotation of screw 42. FIG. 5 shows bearing support device 80 without a bearing assembly. A central hole 83 is provided in bearing support device 80 for receiving bearing assembly 82. Longitudinal apertures 84 are provided around hole 83 to provide various potential advantages. For example, longitudinal apertures 84 may allow greater range of manufacturing tolerance for support device 80 and its ability to accommodate bearing assemblies of slightly varying dimension. Apertures 84 may also provide some degree of bend or spring in cross-portions 88, thereby providing a clamping effect on the bearing assembly. For example, FIG. 8 shows the original position of cross-portion 88 in dashed lines, and the slightly adjusted position of cross-portion 88 when securing bearing assembly 82.

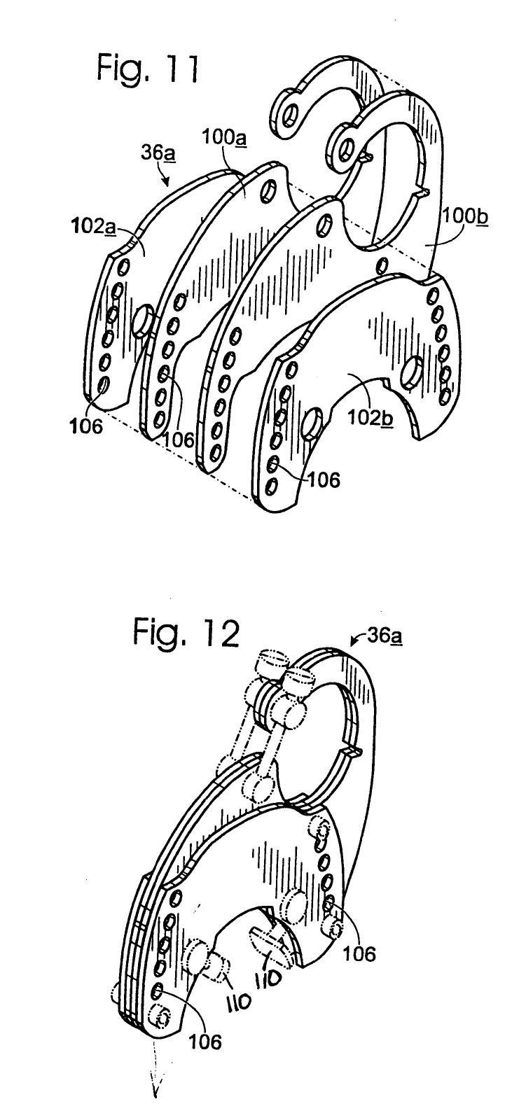

FIGS. 9-12 show different aspects of clamp or linkage device 36a. As shown in FIG. 11, clamp 36a includes four main pieces. Sheet pieces 100a and 100b are sandwiched between sheet pieces 102a and 102b. Sheet pieces 102a and 102b are configured for rigid attachment to positioning guide rail 34. All four pieces include holes 106 for bolting the sandwich together, as shown in FIG. 12. FIGS. 9 and 10 show that multiple holes 106 allow the position of sheet pieces 100a and 100b to be altered relative to sheet pieces 102a and 102b and the positioning guide rail to accommodate different fence positioning rail configurations. External sheet pieces 102a and 102b may be attached to T-grooves in positioning guide rail 34 by T-bolt devices 110, as shown in FIG. 2.

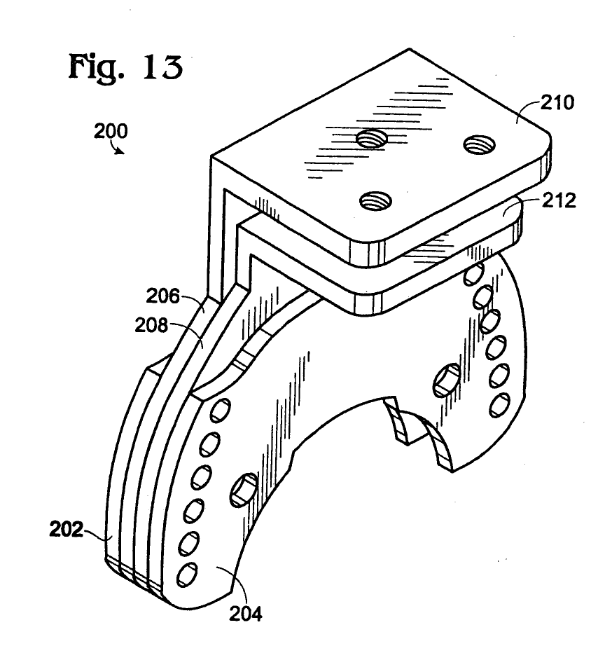

FIG. 13 shows another linkage device 200. Outer plate members 202 and 204 are configured for fastening to external T-slots in a cylindrical guide rail, for example, as previously described. Inner plate members 206 and 208 have flanges 210 and 212 configured for attaching inner plate members 206 and 208 to a substantially planar surface in contrast to the cylindrical surface of fence positioning rail 30. Thus, standard outer plate members 202 and 204 may be used with different inner plate members to connect positioning guide rail 34 to different structures.

The specific embodiments disclosed and illustrated herein should not be considered as limiting the scope of the invention. Numerous variations are possible without falling outside the scope of the appended claims. For example, the invention may be implemented in numerous different machine configurations with varying levels of automation. The invention may also be used to process many different kinds of materials including, but not limited to, wood, wood composites, polymeric materials such as PVC, polystyrene, polypropylene, polyethylene, fiberglass, textiles, etc. In addition to cutting, the invention may be used to carry out other processing steps such as bonding, sewing, heating, UV curing, painting or graphics application, etc. The subject matter of the invention includes all novel and nonobvious combinations and subcombinations of the various elements, features, functions, and/or properties disclosed herein.

1. A system for cutting dados in a work piece comprising
a work table defining a linear processing path,
a cutting station having a blade component located along the processing path,
a pusher device configured to push a work piece along the processing path toward the cutting station,
a controller programmed to drive the pusher device to push a work piece successive adjacent increments downstream between saw cuts, thereby forming a dado of desired dimensions.

2. The system of claim 1, wherein the blade component includes a circular saw blade.

3. The system of claim 1, wherein the controller is programmed to operate off of a cut list, the pusher device being driven to position a work piece for length trimming and dado formation.

4. The system of claim 1, wherein the controller is programmed to optimize cutting of raw material based on a cut list entered in the controller.

5. The system of claim 1, wherein the controller includes a computer.

6. A method of cutting dados in a work piece comprising
providing a linear processing path, a cutting station having a blade component located along the processing path, a pusher device configured to push a work piece along the processing path toward the cutting station, and a controller for driving the pusher device,
automatically pushing a work piece successive adjacent increments downstream between saw cuts, thereby forming a dado of desired dimensions.

7. The method of claim 6, further comprising
programming the controller to optimize length cutting of raw material based a pre-determined cut list.

8. The method of claim 6, further comprising
automatically pushing a work piece into position for a length cut prior to forming a dado in the work piece.

9. The method of claim 6, wherein multiple dados are formed in the same work piece.
